(19) United States
(12) Patent Application Publication
(10) Pub. No.: US 2002/0196724 A1
(43) Pub. Date: Dec. 26, 2002

(54) Cover for magnetic or optical hard disk drive

(76) Inventor: Joseph Reid Henrichs, Lee's Summit, MO (US)

Correspondence Address: Joseph Reid Henrichs, 641 Northeast Swann Circle, Lee's Summit, MO, 64086, US

(21) Appl. No.: 09/891,427

(22) Filed: Jun. 26, 2001

(51) Int. Cl. G11B 33/02; G11B 5/012; G11B 17/00; G11B 33/14

(52) U.S. Cl. 369/75.1; 360/97.01; 360/97.02

(57) ABSTRACT

This invention, in general, relates to a magnetic or magneto-optical hard disk drive cover constructed using a carbon-fiber and/or carbon-black filled “Liquid Crystal Polymer” (LCP) resin that is injection molded to form the previously mentioned magnetic or magneto-optical hard disk drive cover. Using injection molded LCP materials and methods can attain an increased dimensional precision. The carbon-fiber and/or carbon-black filled LCP hard disk drive cover is able to attain the requisite rigidity needed to endure vibrations caused by latency eliminating spindle-motors with ever increasing “Revolutions Per Minute” (RPM) properties without using any structural reinforcing metal frames or metal inserts. The addition of carbon-black to a carbon-fiber filled LCP makes a hard disk drive cover constructed from such material, electrically conductive and therefore, acts when installed onto a grounded hard disk drive, as an “Electro-Static Discharge” (ESD), and/or “Electro-Magnetic Interference” (EMI) device.

### REFERENCE TO RELATED APPLICATION

Not Available

### FEDERALLY SPONSORED RESEARCH OR DEVELOPMENT

Not Available

### REFERENCE TO MICROFICHE APPENDIX

Not Available

### BACKGROUND OF THE INVENTION

1.) Field of the Invention

This invention, in general, relates to a magnetic or magneto-optical hard disk drive cover constructed using a graphite, carbon-fiber, and/or carbon-black filled “Liquid Crystal Polymer” (LCP) resin that is injection molded to form the previously mentioned magnetic or magneto-optical hard disk drive cover. An increased dimensional precision is attained by using injection molded LCP materials and methods. The graphite, carbon-fiber, and/or carbon-black filled LCP hard disk drive cover is able to attain the requisite rigidity needed to endure vibrations caused by latency eliminating spindle-motors with ever increasing “Revolutions Per Minute” (RPM) properties without using any structural reinforcing metal frames or metal inserts. Carbon-fiber is normally added to LCP materials to produce a uniform “Coeffificient of Thermal Expansion” (CTE) throughout the LCP material, but also serves to greatly strengthen the LCP material, as well.

In addition, the previously mentioned carbon-fiber increases the hard disk drive cover's rigidity, giving it the ability to withstand vibrations, and other disturbances, while decreasing the hard disk drive cover's weight thereby, causing its resonance point to increase. The addition of carbon-black to the previously mentioned carbon-fiber filled LCP makes a hard disk drive cover, constructed from such material, electrically conductive and therefore, acts when installed and grounded to a system, as an “Electro-Static Discharge” (ESD) and/or “Electro-Magnetic Interference” (EMI) device. This gives the previously mentioned hard disk drive cover the ability to redirect electro-static discharge to a hard disk drive's grounded system avoiding therein, the possible destruction of the hard disk drive's static sensitive circuitry and/or components.

Moreover, the graphite, carbon-fiber, and/or carbon-black filled LCP resin, when used in the construction of the hard disk drive's cover, improves the vibration characteristics of both the hard disk drive cover and the hard disk drive it is installed onto. The present invention also reduces manufacturing costs by eliminating the need to machine, process, and clean the hard disk drive cover prior to its assembly. The present invention also eliminates the need to apply any special anti-corrosive coating to protect the previously mentioned hard disk drive cover from oxygen induced corrosion.

2.) Background Art

Moreover, hard disk drives are widely used as auxiliary memory devices in computer systems to magnetically or optically record digital information received as a recording apparatus for recording data received from an external device, such as a host computer, onto a magnetic or optical recording medium, such as a rotating disk, or reading data that has already been recorded onto said disk. A hard disk drive includes a housing that has a casting-base and an attached cover, a mechanism unit having a spindle-motor for rotatably mounting the magnetic or optical disk, a data-head for reading and writing data onto said disk, an actuator and a voice-coil motor for controlling the position of said data-head, and a circuit unit for performing the electrical process and controlling of the overall operation of the magnetic or magneto-optical hard disk drive assembly unit.

Moreover, a hard disk drive has a flying magnetic or magneto-optical data-head attached at the end of an actuator arm that moves over a hard disk drive's data containing disk platters to transcribe or retrieve digital information to or from its disk platter's data-surfaces. The beforementioned actuator arm pivots radially around a shaft on a pivot bearing controlled by a voice-coil motor. The beforementioned disk platters are rotated at a constant high rotational speed by a spindle-motor that is attached to the casting-base of the magnetic or magneto-optical hard disk drive's unit assembly.

Moreover, a magnetic or magneto-optical data-head writes or reads digital information, as data, to or from a predetermined cylinder/track location (i.e., an unbroken circle concentrically positioned on the surface of a hard disk drive's disk-platter), the constant angular velocity rotation (i.e., having a constant rotational speed) of a hard disk drive's data containing disk platter, causes the previously mentioned data-head to be aerodynamically lifted up over the surface of the beforementioned disk platter by an air-bearing.

Furthermore, this aerodynamic lifting process results from the flow of air produced by the constant angular velocity rotation of the previously mentioned disk platter. The beforementioned air flow causes a data-head(s) to float or be flown (i.e., thus the term flying-head or flying-head assembly) above disk platter data-surfaces, allowing the previously mentioned data-heads to be freely moved, by the previously mentioned voice-coil motor, over data-surfaces, on a cushion of air, having a maintained minute gap.

However, during operation, when the hard disk drive is idle or during a power down period, the data-heads (i.e., data-heads meaning, data-head assembly) are moved, via their actuator arms, into, and held, in a position over what is normally called a disk-platter's parking-area (i.e., sometimes called a disk-platter's parking zone) located on the innermost track of the previously mentioned disk-platter.

Moreover, the purpose of adjusting the actuator arm data-head assembly during periods when the hard disk drive is not rotating its disk-platter assembly is to prevent data, previously recorded onto a disk-platter's data-surface, from being damaged when the magnetic or magneto-optical data-heads slide onto, against, and across disk-platter data-surfaces, as the previously mentioned data-heads, due to air flow loss, loose their aerodynamic lift.

In addition, a magnetic or magneto-optical hard disk drive also has a “Printed Circuit Board” (PCB), which is connected, via a signal cable, to the hard disk drive's various electronic components, including the hard disk drive's data-head assembly, voice-coil motor current terminals, and spindle-motor current terminals. While the cover of a hard disk drive's unit-assembly is typically used to protect the hard disk drive's contaminant sensitive internal components.

Moreover, it is also used to control vibrations and other similar disturbances. As such, the previously mentioned cover must have sufficient strength to endure the vibration disturbances that occur during normal operation, because during normal operation data-heads are flown at a distance of one-micron or less above the disk-platter data-surfaces of the hard disk drive.

Moreover, as the weight of the cover increases, the first harmonic frequency the hard disk drive is lowered, thus making it easier for the hard disk drive to reach a resonance condition that would interfere with the normal operation of the hard disk drive. Therefore, when designing a hard disk drive cover one must take into account the effect a cover has on the previously mentioned vibration.

Currently, the majority of hard disk drive manufactures use a die-casting method using aluminum material to produce a cover. Since the aluminum die-casting process uses an injection molding process, pores are formed in the inside of the cover that can change the properties of the aluminum material used in the casting, by causing either corrosion or outgasing. To compensate for this deficiency, an E-Coating technique is often used after the injection molding process. Not only does the E-Coating technique cause the cost of production to rise, but, also, due to outgassing problems, manufactures are trying to find other coating techniques.

Furthermore, after injection into molding, a molded aluminum cover, due to the dimensional imprecision of die-casting, is not ready for use until it has been machined to predefined tolerances. Moreover, the machining of the cover creates a lot of debris that has to be removed afterwards with ultrasonic or some other cleaning process before it can be assembled into a hard disk drive unit-assembly. Additionally, the required machining, cleaning, and E-Coating all processes that further increase the cost of producing a hard disk drive unit assembly.

In addition, die-casting using magnesium material has also been developed to try to improve the vibration characteristics of the hard disk drive, but magnesium's susceptibility to corrosion has made it problematic to use in hard disk drive covers designed using a substantial amount of magnesium in their construction. However, hard disk drive manufactures continue to make every possible effort to minimize vibration, while providing the necessary protection to their hard disk drive products and the digital information stored therein, but it is still not easy to find an absolute solution to these problems.

Moreover, this new cover design will provide existing magnetic and magneto-optical hard disk drives with many improvements over existing cover solutions:

i.) A hard disk drive cover that is very light, yet, very strong;

ii.) A hard disk drive cover that does not use the die-casting method of manufacturing;

iii.) A hard disk drive cover that does not require the use of machining to meet dimensional requirements;

iv.) A hard disk drive cover that does not require expensive E-Coating and other anti-corrosive coating processes;

v.) A hard disk drive cover that does not required, during manufacturing, the extra steps involved when using mounting posts; and

vi.) A hard disk drive cover that is highly rigid, electro-static dissipating, electromagnetic interference blocking, and has lower vibration characteristics.

### SUMMARY OF THE INVENTION

Accordingly, the first specific object of the present invention is to provide an improved LCP resin magnetic or magneto-optical hard disk drive cover.

It is another specific object of the present invention to provide a magnetic or magneto-optical hard disk drive cover that has increased dimensional precision, thus eliminating the need to machine, and clean post manufactured hard disk drive covers before their installation into hard disk drive unit assemblies.

It is another specific object of the present invention to provide a magnetic or magneto-optical hard disk drive cover that has improved vibration characteristics.

It is yet another specific object of the present invention to provide a magnetic or magneto-optical hard disk drive cover that has good anticorrosive properties, thus eliminating the need to apply special E-Coatings to post manufactured hard disk drive covers.

It is yet another specific object of the present invention to provide a magnetic or magneto-optical hard disk drive cover that has increased rigidity and strength without the use of metal inserts or metal frames to reinforce the hard disk drive cover's structural strength.

It is yet another specific object of the present invention to provide a magnetic or magneto-optical hard disk drive cover that has a reduced cost of production.

It is yet another specific object of the present invention to provide a magnetic or magneto-optical hard disk drive cover that increases the efficiency of magnetic or magneto-optical hard disk drive production, by eliminating time consuming and costly production processes.

It is yet another specific object of the present invention to provide a magnetic or magneto-optical hard disk drive cover that eliminates the use of metal hole inserts used for reinforcing fastening hole structures, thus reducing the cost of production for the hard disk drive's cover.

It is yet another specific object of the present invention to provide a magnetic or magneto-optical hard disk drive cover that increases thermal deflection of ambient heat, thus protecting the hard disk drive from heat related problems.

It is yet another specific object of the present invention to provide a magnetic or magneto-optical hard disk drive cover that protects the hard disk drive's internal and external PCB electronics from destructive electro-static discharge, while giving added protection to a hard disk drive from electromagnetic interference.

In addition, these and other objects can be achieved by constructing a hard disk drive cover using a graphite, carbon-fiber, and/or carbon-black filled LCP resin. Wherein, the previously mentioned graphite, carbon-fiber, and/or carbon-black filled LCP resin is much lighter than conventional metallic hard disk drive covers, thus lowering the weight of the hard disk drives that use them. Furthermore, by lowering the weight of the hard disk drive, resonant frequencies are increased, thus improving the vibration characteristics of the hard disk drive.

In addition, by using graphite, carbon-fiber, and/or carbon-black filled LCP resin in a LCP low pressure version of injection molding, we can inexpensively construct a hard disk drive cover with improve dimensional accuracy that is much superior to die-caste hard disk drive covers, while adding the extra advantage of being a system grounded EMS device that is capable of discharging, from a user, any built-up electro-static charge, via the hard disk drive cover, to grounded system rather than the hard disk drive itself or any of its static sensitive electronic components.

### BRIEF DESCRIPTIONS OF THE DRAWINGS

A more complete appreciation of this invention, and many of the attendant advantages thereof, will be readily apparent as the same becomes better understood by reference to the following detailed description when considered in conjunction with the accompanying drawings, which like reference symbols indicate the same or similar components; wherein, the figures in the drawings comprise:

FIG. 1 is an orthographic plan-view drawing of the magnetic or magneto-optical hard disk drive cover.

FIG. 2 is an orthographic front-view drawing of the part illustrated in FIG. 1, the magnetic or magneto-optical hard disk drive cover.

FIG. 3 is an orthographic side-view drawing of the part illustrated in FIG. 1, and FIG. 2 the magnetic or magneto-optical hard disk drive cover.

FIG. 4 is a 3-D perspective drawing of the part illustrated in FIG. 1, FIG. 2, and FIG. 3, the magnetic or magneto-optical hard disk drive cover.

### DETAILED DESCRIPTION OF A PREFERRED EMBODIMENT

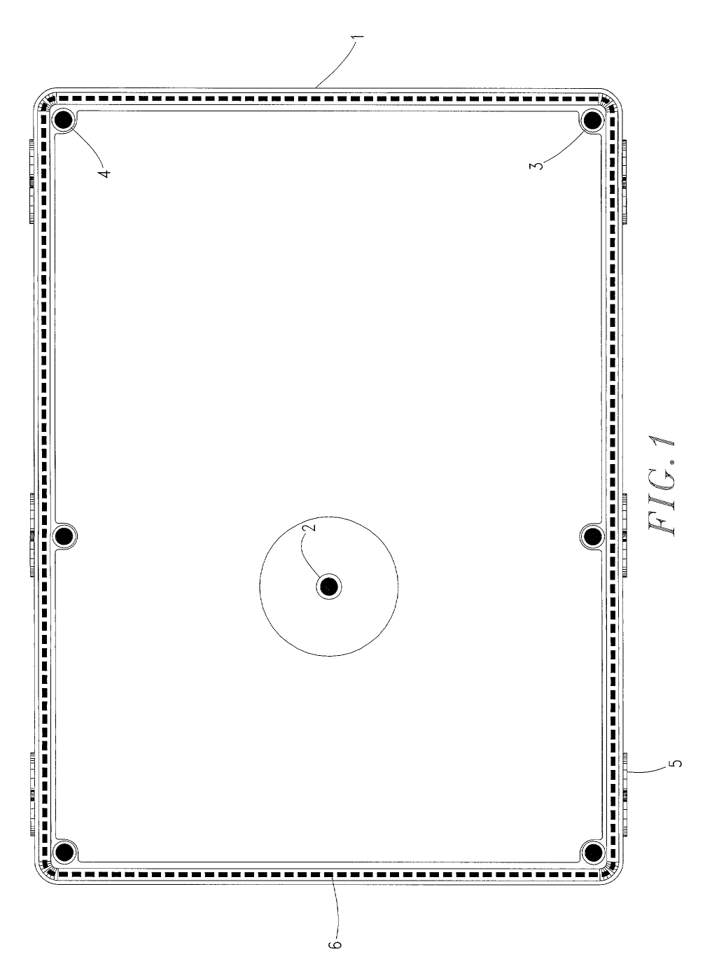

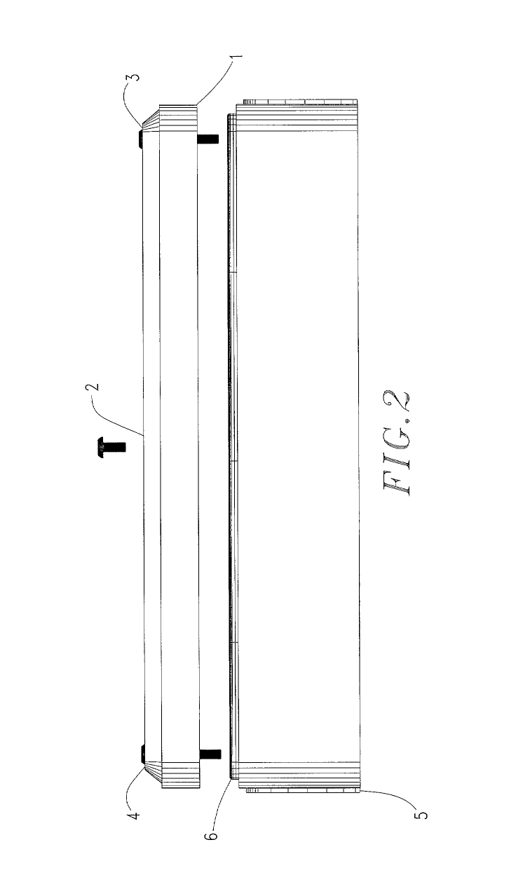

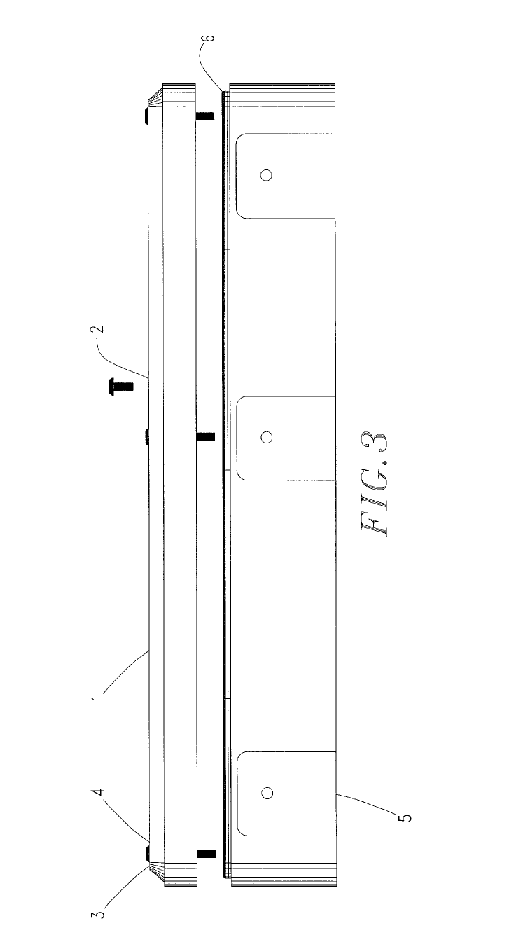

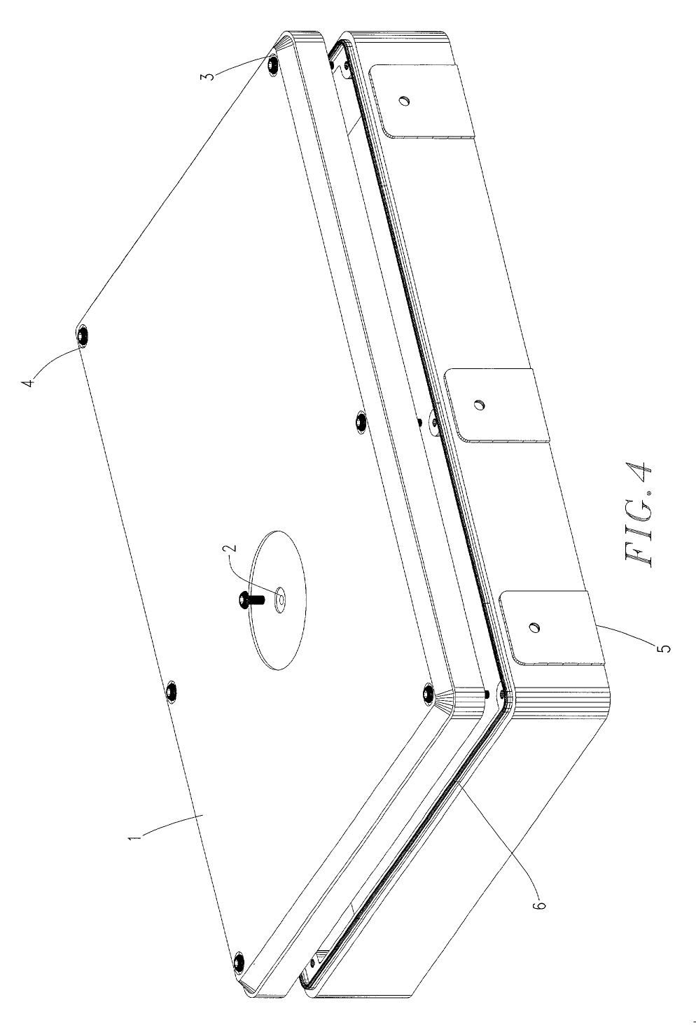

In order to understand the invention as described below in the detailed embodiments we will now turn to the drawing figures and what they describe, as well as define, by way of illustration. Moreover, illustrated in FIG. 1 is an orthographic plan-view or top-view drawing illustrating the layout and structure of the magnetic or magneto-optical hard disk drive cover. Moreover, the previously mentioned magnetic or magneto-optical hard disk drive cover 1 (FIGS. 1, 2, 3, and 4) is constructed, according to the principles of the present invention, from a graphite, carbon-fiber, and/or carbon-black filled LCP resin, which is utilized as the resin material in the injection molding process. Furthermore, because of the rigidity exhibited by the beforementioned graphite, carbon-fiber, and/or carbon-black filled LCP resin, metal inserts or frames are not necessary for constructing a strong, a rigid, and a lightweight magnetic or magneto-optical hard disk drive cover.

In addition, because LCP materials have a low viscosity level they have the flow characteristics necessary for a low-pressure injection molding process that allows the dimensional accuracy of a hard disk drive cover to be greatly improved.

Moreover, because the cover is manufactured using injection molding cover mounting holes 2 (FIGS. 1, 2, 3, and 4) can be created at the time of injection molding by using intermediate insertions, driven by a press, that perforate throughout the surface of the hard disk drive cover 1 (FIGS. 1, 2, 3, and 4). A vibration resistant hard disk drive cover is formed when vibration resistant graphite, carbon-fiber, and/or carbon-black filled LCP resin is injected into a mold, at a relative low pressure when compared to other plastic resins, thus forming the vibration resistant material into the shape of a ready to be installed magnetic or magneto-optical hard disk drive cover. Furthermore, unfilled LCPs are thermoplastic materials that typically have a Rockwell hardness of around eighty-four on a M-Scale and a tensile impact strength of around 2,300 J/m.

Moreover, the strengths and modulus values of unfilled LCPs, at normal room temperatures, are high and compatible with those of ABS resins. However, the strengths and modulus values of carbon filled LCPs, at normal room temperatures, are much higher than those exhibited by ABS resins.

In addition, as shown in FIGS. 1, 2, 3, and 4 the previously mentioned hard disk drive cover is formed with its cover mounting holes intact 2 (FIGS. 1, 2, 3, and 4). Because the graphite, carbon-fiber, and/or carbon-black filled LCP resin material is so much stronger than unfilled LCPs, the cover's mounting holes 2 will not need any metal hole inserts to reinforce their molded structures 2 (FIGS. 1, 2, 3, and 4).

As previously discussed, it is preferable to use a graphite, carbon-fiber, and/or carbon-black filled LCP resin material to construct a magnetic or magneto-optical hard disk drive's cover, because it reduces weight and therefore, allows the magnetic or magneto-optical hard disk drive's cover to be used as a component for absorbing vibration. The previously mentioned reduction in a hard disk drive cover's weight makes the cover's resonance point increase, thus improving the vibration characteristics of the hard disk drive's unit-assembly the previously mentioned hard disk drive cover is installed within.

Furthermore, the cover's increased high dimensional accuracy, due to the injection molding process, eliminates any need to do any machining and cleaning of the hard disk drive cover prior its hard disk drive installation. This will reduce the cost of production and prevent the possible contamination of a hard disk drive from particle residue that was machined off the hard disk drive's cover during manufacturing to bring its dimensions within predetermined tolerances.

Furthermore, the use of LCP resins in the construction of the previously mentioned hard disk drive cover eliminates the out gassing problem associated with die-cast molding processes. Thus, eliminating the additional cost of having to apply an anti-corrosive E-Coating to the hard disk drive cover.

In addition, the addition of carbon-black to the previously mentioned carbon-fiber filled LCP makes a hard disk drive cover electrically conductive. Therefore, serves when installed and grounded to a system, as an “Electro-Static Discharge” (ESD) and/or “Electro-Magnetic Interference” (EMI) device. This gives the previously mentioned hard disk drive cover the ability to redirect electro-static discharge to a hard disk drive's grounded system avoiding therein, the possible destruction of the hard disk drive's static sensitive circuitry and/or components.

However, the previously mentioned hard disk drive cover will need either an electrically conductive metal insert 3 (FIGS. 1, 2, 3, and 4) or an application of an electrically conductive silver paint 4 (FIGS. 1, 2, 3, and 4) to one or many of its cover mounting hole locations 2 (FIGS. 1, 2, 3, and 4). In addition, use of a gasket 6 (FIGS. 1, 2, 3, and 4), which is located between a magnetic or magneto-optical hard disk drive's cover and the magnetic or magneto-optical hard disk drive's casting-base 5 (FIGS. 1, 2, 3, and 4) will further help to insure that the magnetic or magneto-optical hard disk drive's internal environment is clean and free of air-borne particle contaminants, like dust.

Consequently, the rigid-rod nature of LCP molecules results in a profile of molecular orientation that resembles the physical orientation of the fibers in a reinforced thermoplastic material. In addition, the “fountain flow” effect that occurs during the injection mold filling process causes the LCP molecules on the surface of the flow front to stretch into an elongated flow.

Ultimately, these molecules are located on the part surface, which results in a skin that is oriented in the elongated flow's direction. The previously mentioned skin may be 15-30% of the part's total thickness. Therefore, as the part becomes thinner the skin percentage will increase making the part more rigid and strong. While, during mold filling, the core of the part is subject to shear forces, causing a “tumbling” effect, wherein, the core LCP molecules eventually are oriented more or less perpendicular to the elongated flow's direction. This behavior mirrors the orientation of glass fibers in the core of a part reinforced with short fibers. The flow behavior previously discussed, causes a self-reinforcing effect to occur; wherein, the skin or outer portion of a molded part becomes highly oriented giving exceptional flexural strength and modulus, as well as good tensile performance.

### CONCLUSION, RAMIFICATIONS, AND SCOPE

Although, this preferred embodiment of the present invention has been disclosed for illustrative purposes, those skilled in the art will appreciate that various modifications, additions, and substitutions are possible, without departing from the scope and spirit of the invention as disclosed in the accompanying claims. It is also possible that other benefits or uses of the currently disclosed invention will become apparent over time. device, giving said cover the ability to redirect electro-static discharge to a grounded system, avoiding therein, destruction of said data storage device's static sensitive circuitry and components.

1. A magnetic or optical hard disk drive cover, comprising:
a) a magnetic or optical hard disk drive cover constructed from an electron conducting liquid crystal polymer resin,
whereby, said magnetic or optical hard disk drive cover by using said electron conducting liquid crystal polymer resin increases said magnetic or optical hard disk drive cover's rigidity, giving it the ability to withstand vibrations, and other disturbances, while decreasing said magnetic or optical hard disk drive cover's weight thereby, causing its resonance point to increase.

2. A hard disk drive cover, comprising:
a) a hard disk drive cover constructed using electron conducting carbon comprising liquid crystal polymer resin, and electron conducting paint,
whereby, said hard disk drive cover also reduces manufacturing costs by eliminating the need to machine, process, and clean said hard disk drive cover prior to its assembly therein, eliminating the need to apply special anti-corrosive coating to protect said hard disk drive cover from oxygen induced corrosion.

3. A data storage device housing cover, comprising:
a) a data storage device's housing cover constructed from any combination of graphite, carbon-fiber, or carbon-black filled liquid crystal polymer resin,
whereby, said data storage device housing cover, by adding graphite, carbon-fiber, or carbon-black to said liquid crystal polymer resin used in its construction makes. used in its construction, said cover electrically conductive and therefore, when installed to a grounded system, causes said cover to act as an electro-static discharge and electro-magnetic interference device, giving said cover the ability to redirect electro-static discharge to a grounded system, avoiding therein, destruction of said data storage device's static sensitive circuitry and components.
